(19) United States
(12) Patent Application Publication
(10) Pub. No.: US 2006/0146910 A1
(43) Pub. Date: Jul. 6, 2006

(54) Method and apparatus for simultaneous velocity and temperature measurements in fluid flow

(76) Inventors: Manoochehr Koochesfahani, Okemos, MI (US); Hui Hu, Ames, IA (US); Charles P. Gendrich, Middletown, CT (US)

Correspondence Address: HARNESS, DICKEY & PIERCE, P.L.C., P.O. BOX 828, BLOOMFIELD HILLS, MI, 48303, US

(21) Appl. No.: 11/285,783

(22) Filed: Nov. 22, 2005

Related U.S. Application Data
(60) Provisional application No. 60/635,566, filed on Nov. 23, 2004.

(51) Int. Cl. G01K 11/00; G01P 3/36

(52) U.S. Cl. 374/161; 356/28

(57) ABSTRACT

Disclosed is a method and apparatus for simultaneously measuring the temperature and velocity of a working fluid. The system utilizes a pulsed laser to tag phosphorescent tracer molecules disposed within the working fluid. A CCD camera is used to measure the movement of the tagged molecules as well as the change in emission intensity of the photoluminescent material. The decay rate of the laser induced phosphorescence is used to derive the fluid temperature.

### CROSS-REFERENCE TO RELATED APPLICATIONS

This application claims the benefit of U.S. Provisional Application No. 60/635,566, filed on Nov. 23, 2004. The disclosure of the above application is incorporated herein by reference.

### FIELD

The present invention relates to a method and apparatus of measuring the velocity and temperature of a fluid and, more particularly, to a method and apparatus to simultaneously measure the temperature and velocity of a fluid at numerous points throughout a fluid.

### BACKGROUND

Velocity and temperature are the two most important parameters to study complex thermal-fluid problems. Experimental techniques capable of achieving whole-field velocity and temperature measurements in fluid flows are highly desirable for the studies of complex thermal-fluid problems for the better performances of a large variety of functional devices like heat exchangers, air conditioners, internal combustion engines and gas turbines. If a fluid flow is turbulent, the temperature field is determined by heat diffusion and transport by the turbulent flow. When one is considering the Reynolds-averaged energy conservation equation, the effect of turbulent transport appears in terms of the correlation between temperature and velocity fluctuations, i.e. turbulent heat flux \overline{uⱼ′T′}. Experimental characterization of these correlation terms is always highly desired for either optimum design of various heat-exchange devices or the development and validation of fundamental physical models, although measurement of turbulent heat flux is still not easy because the velocity and temperature must be measured simultaneously at the same point.

To date, the state-of-the-arts techniques for flow diagnostics are particle-based techniques like Laser Doppler Velocimetry (LDV) or Particle Imaging Velocimetry (PIV), which use tiny particles as diagnostic tracers seeded in flows. Many issues and implications due to the inertia and buoyancy of the tracer particles may constrict the applications of the particle-based techniques to make physically meaningful measurements in fluid flows. These issues and implications are expected to be eliminated if molecules are used as diagnostic tracers since the molecular tracers are soluble the working fluids.

In order to achieve simultaneous velocity and temperature measurements to quantify the correlation between velocity and temperature in turbulent flows, several studies had been conducted by using intrusive probes. Antonia et al. (1975) and Chevray and Tutu (1978) used a cold-wire sensor mounted on an X-wire probe to achieve simultaneous measurements of temperature and velocity in a heated jet flow. Kotsovinos (1977) used the combination of one-dimensional Laser Doppler Velocimetry (LDV) and fast response thermistors to measure velocity and temperature in turbulent buoyant jets simultaneously. All these methods are intrusive measurement methods, which may cause disturbances to flow fields to be measured.

More recently, the advent of optical diagnostics such as LDV, Laser Induced Fluorescence (LIF) and Raman scattering techniques has presented new opportunities for the non-intrusive simultaneous measurements of velocity and temperature in fluid flows. By combining LDV and vibrational Raman scattering, Dibble et al. (1984) measured the velocity and temperature simultaneously in turbulent flames. Taking advantage of the temperature dependence of fluorescence emission, a combined LIF and LDV technique was used by Lemoine et al. (1999) to conduct simultaneous temperature and velocity measurements at the interest points in a turbulent heated jet. These investigations, however, involved single point measurements, which only provide measurement results at a single point or very limited measurement points.

Whole-field diagnostic techniques like Particle Image Velocimetry (PIV) and Planar Laser Induced Fluorescence (PLIF), have led to recent efforts at obtaining simultaneous measurements of velocity and temperature distributions in fluid flows. A combination of PIV and PLIF technique has been used by Sakakibara et al. (1997), Hishida and Sakakkibara (1999) and Grissino et al. (1999) to do simultaneous measurements of velocity and temperature fields to study heat transfer characteristics in turbulent flows. By using Thermochromic Liquid Crystal (TLC) encapsulating micro-spheres as tracer particles, a Digital Particle Image Velocimetry/Thermometry (DPIV/T) technique was developed (Dabiri and Gharib, 1991 and Park et al. 2001) to achieve simultaneous measurements of velocity and temperature fields in turbulent flows.

Since the simultaneous velocity and temperature measurement techniques mentioned above are particle-based techniques, which rely on scattering (PIV, LDV) or reflected light (TLC) from particle tracers to achieve velocity or temperature measurements, the potential implications associated with the use of particle tracers need to be evaluated carefully for each experiment. Some of these implications are related to flow tracking issues, such as, particle size, density mismatch, etc . . . Even if the particles can track the flow perfectly, strong out-of-plane motions that may bring the particle tracers into and out of the laser sheet can affect the accuracy of the in-plane velocity measurements in PIV. For the temperature measurement by using TLC micro-spheres (Dabiri and Gharib, 1991) or LIF dye infused particles (Grissino et al. 1999), additional considerations are also required about the thermal responses of the particle tracers. When PIV is combined with PLIF, additional complications such as the influences of laser light absorption and scattering by the particle tracers on the LIF signal also need to be carefully considered.

For the implementation of PIV/PLIF combined technique, at least two cameras with various optical filters are required to record particle scattering and LIF signals separatedly for the simultaneous velocity and temperature measurements. A very careful image registration or coordinate mapping procedure is also required during the experiment in order to get the quantitative spatial relationship between the simultaneous velocity and temperature measurements.

### SUMMARY

To overcome the problems of the prior art, the MTV&T technique utilizes specially-designed phosphorescent molecules as the working tracers for both velocity and temperature measurements. The molecule tracers in the regions of interest are “tagged” by a pulsed laser. The tagged molecules are interrogated at two successive times within the lifetime of the photoluminescence (phosphorescence) of the tracer molecules. The measured Lagrangian displacement vectors of the “tagged” molecules between the two interrogations provide the estimates of flow velocity vectors.

The MTV&T technique according to the present invention is a ratiometric technique for quantitative fluid temperature measurement that takes advantage of the temperature dependence of the lifetime of laser-induced phosphorescence. The decay rate (lifetime) of the laser-induced phosphorescence is used to derive the fluid temperature. Since the lifetime of the phosphorescence is calculated based on the intensity ratio of the phosphorescence images captured at two successive times after the same laser pulse, the MTV&T technique is a ratiometric and self-calibrated method, which can eliminate the effects of both variation of the incident illumination and non-uniformity of the tracer molecule concentration in the measurement windows.

The fluid diagnostic techniques according to one embodiment of the present invention uses molecular tracers, instead of particles, as working tracers for the MTV&T measurement. As such, the issues and implications due to the inertia and buoyancy of the tracer particles are eliminated for the velocity measurement. As the tracer molecules can be dissolved into the working fluids, the disadvantages associated with the thermal response of the TLC micro-spheres are overcome. The MTV&T technique is able to apply to almost all the thermal-fluid related fields, which ranges from the fundemental studies of thermal-fluid phenomena to the engineering applications of optimum design of various heat exhanger devices.

The MTV&T technique according to the teachings of the present invention utilizes specially-designed molecules as diagnostic tracers for both velocity and temperature measurements. An image is provided to conduct whole-field measurements of flow velocity vectors, as well as to provide the quantitative mapping of temperature distributions in fluid flows simultaneously. As the measurement results, the whole-field instantaneous velocity and temperature fields, mean velocity and mean temperature distributions, temperature and velocity fluctuations as well as the correlation terms between temperature and velocity fluctuations can be obtained by using the MTV&T technique, which offer significant advantages over other diagnostic techniques for the studies of complex thermal-fluid phenomena.

In another embodiment of the present invention, an apparatus for determining the velocity and temperature in a fluid containing a photoluminescent material is disclosed. The apparatus has a first beam of collimated light configured to illuminate a region in the fluid at a time T₀ to energize the photoluminescent material. An image recorder is configured to record the location and the intensity of the resulting illumination of the photoluminescent material at a time T₁, and to record the velocity and temperature of the fluid at the location. The imager is further configured to measure the intensity of and location of the photoluminescent material at a time T₂. A controller is configured to calculate the velocity of the photoluminescent material within the liquid, based on the change of location of the photoluminescent material as well as calculate the temperature of the photoluminescent material based on changes of the intensity of the emission from the photoluminescent material between times T₁ and T₂.

In another embodiment to the present invention, the apparatus contains a grid configured to split a first collimated beam of light into a plurality of generally parallel collimated beams of light and a second grid to split a second collimated beam of light into a second set of generally parallel beams to form an array of beam intersection points which are used to illuminate photoluminescent molecules dispersed within a working fluid. An imager is provided which is configured to record the intensity and the location of all of the photoluminescent material dissolved within the liquid at a time T₁. The imager is further configured to measure the intensity and location of the illuminated molecules at a time T₂. A controller is configured to calculate the velocity and temperature of the material using the position and change in illuminescence of the dissolved photoluminescent material.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DRAWINGS

The present invention will become more fully understood from the detailed description and the accompanying drawings, wherein:

FIG. 1 represents an apparatus for simultaneously measuring the temperature and velocity of a fluid at a number of points;

FIG. 2 represents the phosphorescence intensity versus time for a photoluminescent material at a particular temperature;

FIG. 3 represents an apparatus for measuring the intensity and temperature of a photoluminescent, material within a working solution;

FIG. 4 represents a graph of the lifetime versus temperature for a particular photoluminescent material;

FIGS. 5A and 5B represent the measurement of the velocity and temperature of a liquid using the apparatus showing in FIG. 1;

FIGS. 6A and 6B represent the measurement of the velocity utilizing the system shown in FIG. 1 and FIGS. 5A and 5B;

FIGS. 7A and 7B represent measured instantaneous velocity and temperature information for the fluid measured in FIGS. 5A and 5B;

FIGS. 8A and 8B represent measured spatial maps of the average velocity and temperature fields for a liquid; and

FIGS. 9A and 9B represent mean axial flow velocity and mean axial temperature profiles at specific locations in the flow shown in FIGS. 8A and 8B.

### DETAILED DESCRIPTION

The following description of the preferred embodiments is merely exemplary in nature and is in no way intended to limit the invention, its application, or uses.

The apparatus is configured to generate a grid of intersecting laser lines to “tag” molecular tracers in the wake region downstream a heated cylinder. The pulsed laser beam 36 (20 ns, 150 mJ/pulse) from an Excimer Laser 34 is manipulated by a set of cylindrical optics to increase its aspect ratio. The resulting beam is split by a 50:50 beamsplitter; each of the two resulting beams passes through a beam blocker to generate the laser grid pattern. The beam blocker is simply an aluminum plate with a series of thin slots.

The apparatus 20 determines the velocity and temperature of a working fluid 22 containing a photoluminescent material 24 at a location 26. The system uses a first beam of collimated light 28 configured to illuminate the location within the fluid at a time T₀ to energize the photoluminescent material 24. The image recorder 50 which is configured to record the location and intensity of illumination of the photoluminescent material 24 at a time T₁ and to record the location and intensity of the photoluminescent material at a time T₂. A controller 32 is configured to calculate the velocity of the photoluminescent material 24 based on the change of location of the photoluminescent material 24 and to calculate the temperature of the photoluminescent material 24 based on the change of illuminescence of the photoluminescent material between time T_{1 and T}₂.

The photoluminescent material 24 is preferably a supramolecule which is dissolvable within the fluid 22. By making the supramolecule dissolvable, the buoyancy problems associated with suspended particles are obviated. The selection of molecular tracers depends on the type of working fluids 22 to be used for the experiment. Preferably, supramolecules of 1-BrNp.Gβ-CD.ROH chemical triplex is used as MTV&T tracers for the simultaneous velocity and temperature measurements in water flows.

The photoluminescent material has a first emission intensity I₁ at T₁ and a emission intensity I₂ at T₂ and wherein the imager is capable of measuring the emission intensity at T₁ and T₂. Important in the realization of the system is the requirement that the system utilizes components where T₂ minus T₁ is of sufficient duration to allow the image recorder to detect the movement of the photoluminescent material from a position P₁ to a position P₂.

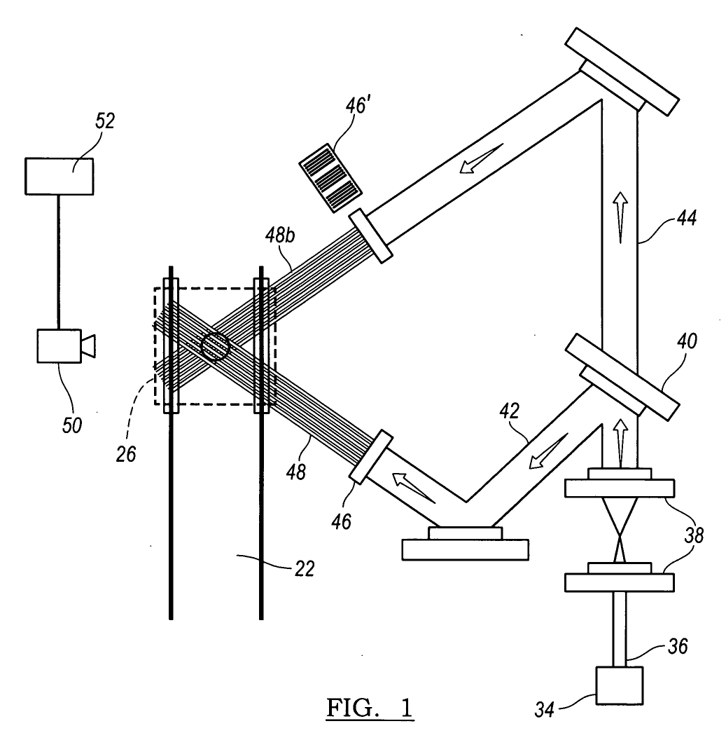

As shown in FIG. 1, in its basic form the apparatus 20 uses a second beam of collimated light configured to intersect the first beam of collimated light at the location to be measured. By crossing two beams of light at a single location, the photoluminescent material is illuminated at a higher energy level. Should the flow of the liquid move the photoluminescent material along the line of one of the illuminative beams, movement of the doubly illuminated material is detectable.

As shown in FIG. 1, the system utilizes a laser 34 to form a collimated coherent beam of light 36. A cylindrical lens 38 is used to modify the profile of the beam. A beam splitter is used to divide the beam 36 into a pair of first and second collimated beams 42 and 44. A set of mirrors are used to direct these beams into intersecting alignment over a working fluid 22. A pair of slotted beam blockers 46 and 46′ are used to form a series of collimated beams 48a and 48b. These collimated beams form an array of beam intersection points that form an array of illuminated photoluminescent materials. The imager 50, in the form of a gated intensified CCD camera, interrogates the photoluminescent intensity of the “tagged” molecular tracers 24 at two successive times. As described below, the controller 52 uses these images to calculate the velocity and temperature of each point of the array illuminated photoluminescent materials.

MTV is a whole field optical technique, which relies on photoluminescent molecules that can be turned into long lifetime tracers upon excitation by photons of appropriate wavelength. Typically a pulsed laser is used to “tag” the regions of interest, and those tagged regions are interrogated at two successive times within the lifetime of the tracer. The measured Lagrangian displacement of the tagged molecules provides the estimate of the velocity vector. The technique can be thought of as essentially a molecular counterpart of PIV and can offer advantages in situations where the use of seed particles is either not desirable, difficult, or may lead to complications.

A molecular complex is suitable for molecular tagging applications if its lifetime as a tracer is long enough relative to the flow convection time scale to allow sufficient displacement of the tagged regions during the interrogation time. The photophysical properties of the tracer, in turn, dictate the wavelength and number of photon sources needed for creating the tracer (i.e. the tagging process) and those needed for interrogation.

The work described here takes advantage of a phosphorescent supramolecule as a common molecular tracer for both velocimetry and thermometry. It has been shown that water-soluble supramolecular complexes may be designed to exhibit long-lived phosphorescence, which is not quenched by O₂, upon mixing a lumophore, an appropriate alcohol, and cyclodextrin (Ponce et al. 1993; Mortellaro and Nocera 1996; Hartman et al. 1996). The original design used in MTV (Koochesfahani et al. 1996; Gendrich et al. 1997) is 1-BrNp.Gβ-CD.ROH, a triplex formed by mixing the lumophore (1-BrNp), certain alcohols (indicated collectively by ROH), and an aqueous solution of glucosyl-β-cyclodextrin, Gβ-CD. The resulting long-lived green phosphorescence has a typical lifetime of up to several milliseconds. The current work utilizes the laser induced phosphorescence of a slightly different triplex, 1-BrNp.Mβ-CD.ROH. In this triplex, the original glucose sugar subunits that are hanging off the rim of the cyclodextrin for increased solubility (i.e. glucosyl-β-cyclodextrin, Gβ-CD) have been replaced by maltose (i.e. maltosyl-β-cyclodextrin, Mβ-CD). The measured properties of both glucose- and maltose-based triplexes are quite similar and the two can be used interchangeably. The alcohol (ROH) used is typically either cyclohexanol or neopentanol.

The selection of the specific molecular tracers depends on what type of working fluid is used for the experiment. Although many materials are available, the supramolecules of 1-BrNp.Gβ-CD.ROH chemical triplex are usable as MTV&T tracers for the simultaneous velocity and temperature measurements in water flows.

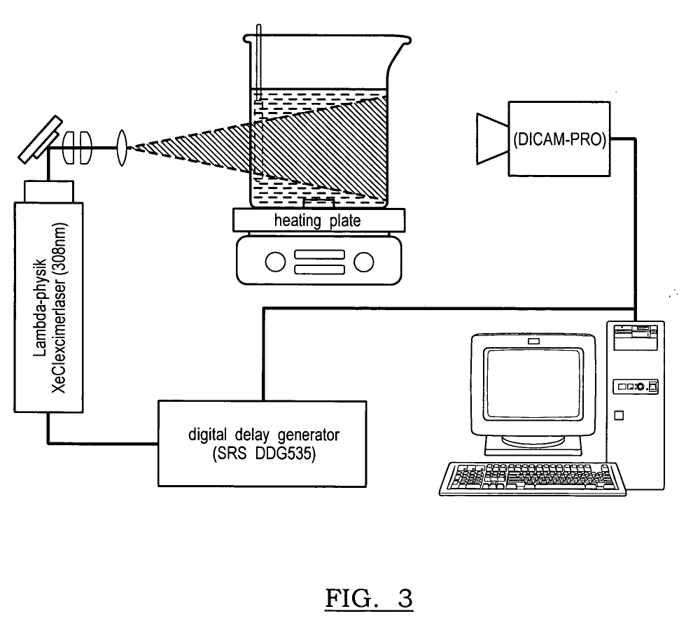

As shown in FIG. 3, a calibration procedure is conducted to quantify the relationship between the photoluminescence intensity decay rate (i.e. lifetime) of the molecular tracers with the temperature of the working fluids for the temperature measurement. According to quantum theory (Pringsheim, 1949), the intensity decay of a first order photoluminescence process (either flourescence or phosphorescence) can be expressed in the form
Iₑₘ=Iₒe^{-t/τ}, (1)
where the lifetime τ refers to the time when the intensity drops to 37% (i.e. 1/e) of the initial intensity Iₒ.

For an excited state, the deactivation process may involve both radiative and non-radiactive pathways. The lifetime of the photoluminescence process, τ, is determined by the sum of all the deactivation rates:
τ⁻¹=kᵣ+kₙᵣ, (2)
where kᵣ and kₙᵣ are the radiative and non-radiative rate constants, respectively. According to photoluminescence kinetics, these non-radiative rate constants are, in general, temperature-dependent. The temperature dependence of the phosphorescence lifetime is the basis of the present technique for temperature measurement.

Now consider capturing the phosphorescence emission by a gated CCD detector where the integration starts at a delay time t₀ after the laser excitation pulse with a gate period of δt. The phosphorescence signal Sₚ collected by the detector is then given by:

$${S}_{p} = {\int }_{{t}_{o}}^{{t}_{o} + δ t} {I}_{o} {ⅇ}^{- t / τ} ⅆ t = {I}_{0} τ ( 1 - {ⅇ}^{- δ t / τ} ) {ⅇ}^{- {t}_{o} / τ} . \qquad ( 3 )$$

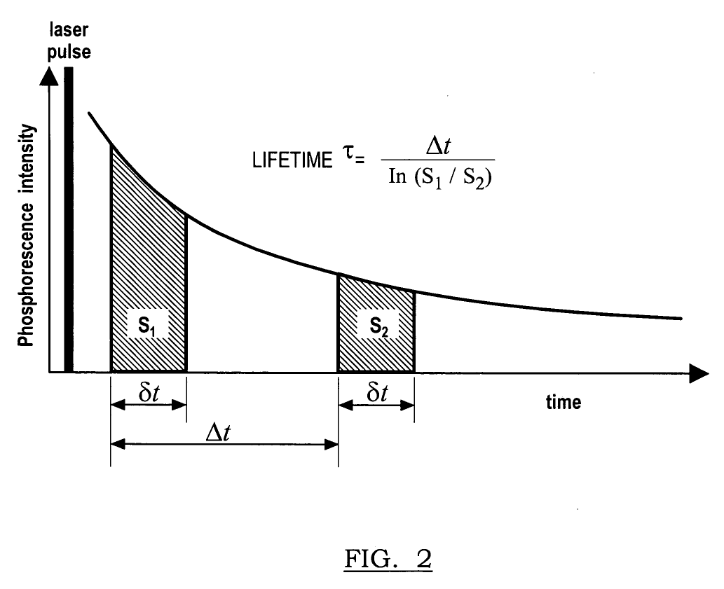

For a typical MTV&T measurement, the phosphorescence signal is imaged at two successive times after pulsed laser excitation (FIG. 2). The first image is detected at the time t=t₁ after laser excitation for a gate period δt to accumulate phosphorescence intensity S₁, while, the second image is detected at the time t=t₁+Δt for the same gate period to accumulate phosphorescence intensity S₂. The intensity ratio of the second image intensity (S₂) to the first image intensity (S₁) will be:

$$\frac{{S}_{2}}{{S}_{1}} = {ⅇ}^{- \frac{Δ t}{τ}} . \qquad ( 4 )$$

As shown in FIG. 2, from Equation (4), it is evident that the intensity ratio of two successive phosphorescence images is only a funtion of phosphorescence lifetime, and not the laser excitation intensity. This eliminates the effects of variation of the incident illumination.

The phosphorescence lifetime can be calculated on a pixel-by-pixel basis from Equation (4) according to

$$τ = \frac{Δ t}{ln ( {S}_{1} / {S}_{2} )} , \qquad ( 5 )$$

resulting in the distribution of the phosphorescence lifetime in a two-dimentional domain based on two sucessive phosphorescence images.

In order to quantify the relationship between the photoluminescence lifetime of molecular tracers and the temperature of the working fluids, a calibration procedure needs to be conducted. FIG. 3 shows a schematic setup for a typical MTV&T calibration procedure.

A calibration cell to contain the solution is prepared. The temperature of the solution in the test cell should be adjustable by using heating devices like electric heaters or heating plates. At a pre-determined temperature level, a pulsed laser is used to “tag” the molecular tracers in the test cell with either a laser beam or a laser sheet. The wavelength of the laser is selected depending on the absorption characterization property of the molecular tracers selected. For the 1-BrNp.Gβ-CD.ROH aqueous solution, the wavelength of the laser is recommended in the range of 250 nm˜310 nm. Optionally, a 308 nm Excimer UV laser can be used to “tag” the 1-BrNp.Gβ-CD.ROH aqueous solution.

The gateable CCD camera 50 is used to interrogate the photoluminescence intensity of the “tagged” molecular tracers 24 at two successive times. FIG. 2 shows the typical timing diagram of the two interrogations related to the laser pulse. The controlling parameters for the image acquisition like exposure time of the camera for each interrogation, the time interval between the two interrogations, and the starting time of the first exposure after the laser pulse are affected by many factors like the power of the pulsed laser, quantum efficiency of the molecular tracers, the temperature of the solution and the camera used for the image recording. For example, when an Excimer UV laser 34 (wavelength 308 nm) at the power of about 100 mJ/pulse is used to “tag” the 1-BrNp.Gβ-CD.ROH aqueous solution (temperature 10° C.˜50° C.), the exposure time of each interrogation is recommended to be about 200 μs˜1 ms for an intensified CCD camera DiaCam-Pro™. The starting time of the first exposure is recommended to be about 1 μs˜1 ms after laser pulse, and the time interval between the first and second image captures can be about 1 ms˜5 ms.

The controller 52 then calculates the intensity ratio (S₁/S₂) of the photoluminescence of the tagged molecular tracers 24 recorded at the first and second interrogations through image processing. Then, the controller 52 calculates the photoluminescence lifetime according to Equation (5). The controller 52 then compares photoluminescence lifetime to previously established values to determine the temperature level at the specific location.

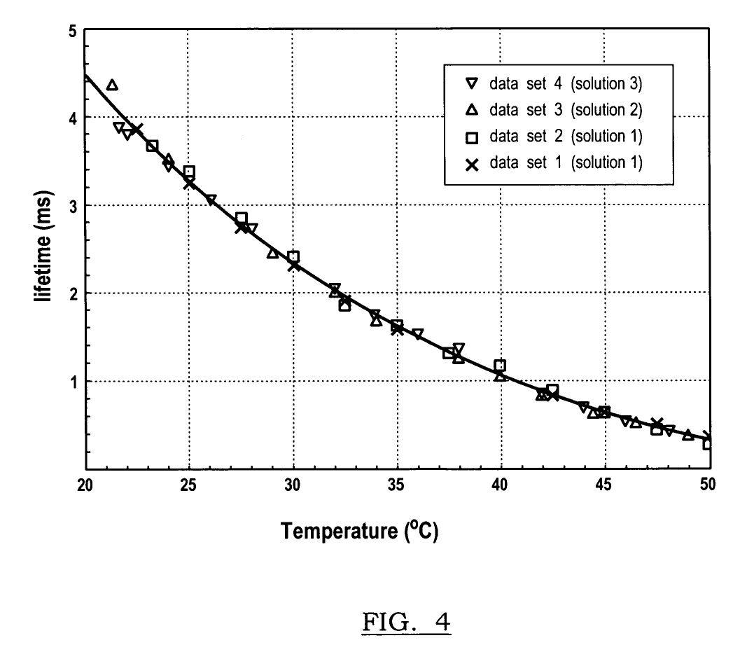

A plot the experimental data of the photoluminescence lifetimes at different temperature levels is shown in FIG. 4. Shown is a typical calibration curve of the variation of the photoluminescence lifetime of the 1-BrNp.Gβ-CD.ROH molecular tracers with the changing the temperature of the 1-BrNp.Gβ-CD.ROH aqueous solution.

From the lifetime versus temperature profiles, it can be seen that the phosphorescence lifetime of the 1-BrNp.Gβ-CD.ROH complex varies significantly with increasing temperature. The relative temperature sensitivity of the phosphorescence lifetime ranges 5.0% per degree at 20.0° C. to 20.0% per degree at 50.0° C. The temperature sensitivity is much higher than those of most commonly-used LIF dyes (for example, the temperature sensitivity of Rhodamine B is about 2.0% per degree).

To perform an experiment, molecule tracers are “tagged” in the regions of interest, and to record the images of the tagged molecules are recorded. MTV&T technique conducts simultaneous temperature and velocity (either one component, two components or even three components of velocity vectors) measurements over a plane. To “tag” the molecular tracers premixed in the working fluids in single or multiple parallel lines can usually provide only one component of the velocity vector, whose direction is normal to the tagged lines. In order to unambiguously measure two components of velocity vector in a plane, the photoluminescence intensity field from a tagged region must have spatial gradients in two, preferably orthogonal, directions. Therefore, laser beams from two directions to generate a grid of intersecting laser lines are usually used to “tag” the molecular tracers premixed in the working fluids for MTV&T measurements. The measurements of complete three components of velocity vectors over a plane can be achieved by using stereo imaging technique with multiple imagers.

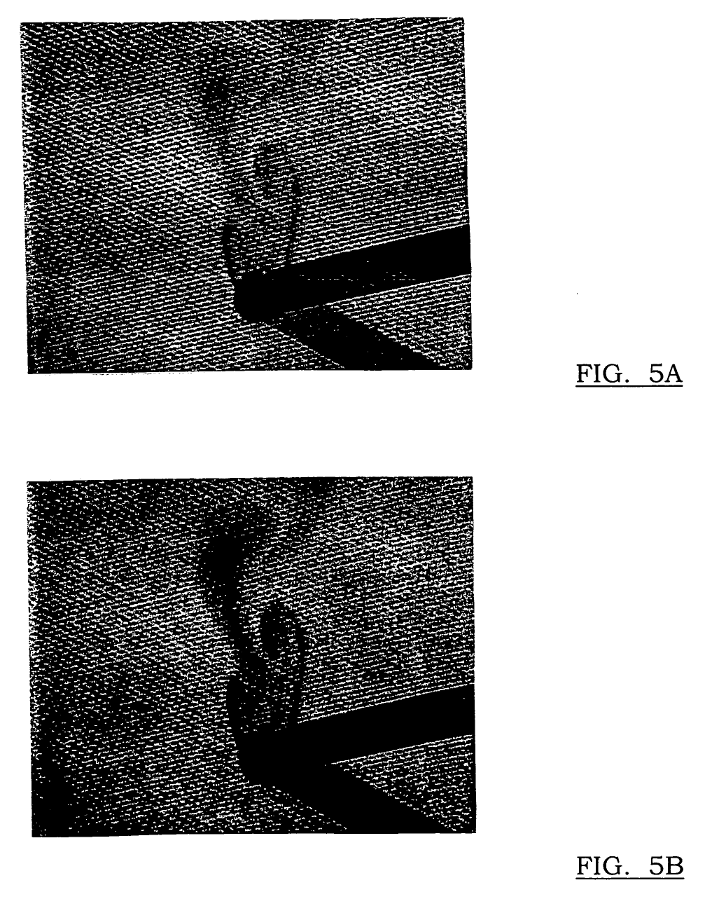

As illustrated in the FIGS. 5a and 5b, two full-frame images of phosphorescence in quick succession are usually acquired after the same laser excitation pulse for a MTV&T measurement. The two full-frame images of phosphorescence can be acquired by using a dual-frame camera or by using two single-frame cameras. A typical pair of the first and second phosphorscence images captured by using a dual-frame intensified CCD camera 50 (PCO DiCAM-Pro) is shown in FIGS. 5a and 5b. The first images are captured at the time delay of 1 ms after the laser pulse with the interrogation gate period of 1 ms. The second phosphorescence image was captured at the time delay of 5 ms after the laser excitation pulse with the same interrogation gate period.

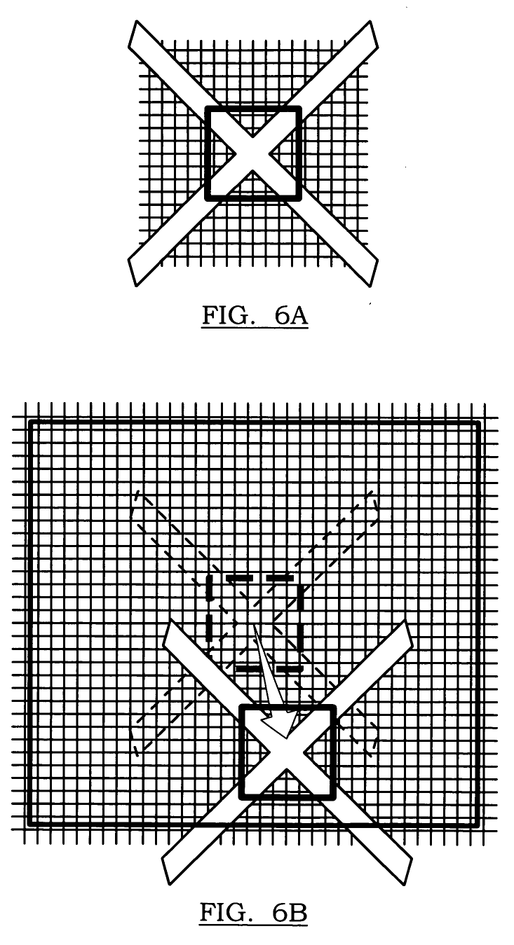

The flow velocity vectors are derived from the recorded images through a image processing procedure. In order to derive flow velocity vectors from recorded MTV&T images, a spatial correlation technique is usually used to find the displacements of tagged regions between the two interrogations. As seen in FIGS. 6a and 6b, a small window, referred to as the source window, is selected from a tagged region in the earlier image, and it is spatially correlated with a larger roam window in the second image. The spatial correlation coefficient R(r, s) between the intensity field I₁ of the source window and I₂ from the roam window as a function of the pixel displacement (r, s) between them:

$$R ( r , s ) = \frac{ \overline{{I}_{1} \cdot {I}_{2}} - {\overline{I}}_{1} \cdot {\overline{I}}_{2}}{{σ}_{1} \cdot {σ}_{2}} \qquad ( 6 )$$

In this expression the overbar refers to the expected value, and or denotes the standard deviation; with this definition, −1≦R≦+1. Sub-pixel accuracy is obtained by fitting the correlation coefficient distribution R(r, s)₁ about the peak value to a two-dimensional polynomial function and locating the maximum in the fit. Based on the displacement vector (Δx, Δy) of the source window obtained through the spatial correlation procedure, the velocity of the “tagged” molecules in the source window is then estimated according to

$$[ \begin{matrix}u \\ v\end{matrix} ] = [ \begin{matrix}\frac{Δ x}{Δ t} \\ \frac{Δ y}{Δ t}\end{matrix} ] \qquad ( 7 )$$

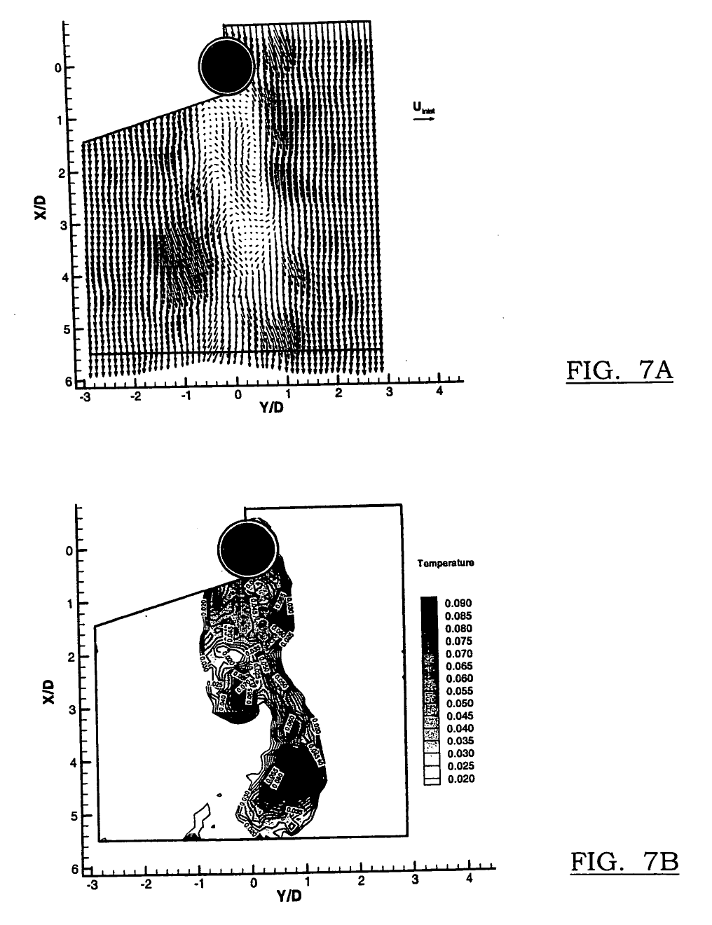

FIG. 7a shows a typical instantaneous velocity field derived from the image pair shown in FIGS. 5a and 5b with the spatial correlation procedure as described above. For the instantaneous velocity field, interrogation windows with the size of 32 pixels by 32 pixels (about 1.2 mm by 1.2 mm) were used for the image processing.

To reconstruct the simultaneous fluid temperature field is constructed by using the calibration profile of photoluminescence lifetime vs temperature. For the velocity measurement, MTV&T technique utilizes only the information about the spatial distributions of the photo-luminescence of the “tagged” molecule tracers to determine the displacement vectors of the “tagged” molecule tracers. The simultaneous temperature distributions in fluid flows can be determined by using the information about the photo-luminescence lifetime of the “tagged” molecular tracers.

For the image processing to construct the simultaneous temperature field, small windows called interrogation windows are chosen in the first phosphorescence image. (The interrogation windows for temperature field reconstruction can be either the same as or different from the interrogations windows used to derive velocity vectors). The corresponding positions of the selected interrogation windows in the second phosphorescence image are determined based on the measured velocity results as shown in FIG. 7(a). The averaged phosphorescence intensities of the corresponding interrogation windows in the first and the second phosphorescence images are calculated. The phosphorescence lifetime of the tagged molecules in each corresponding interrogation windows was calculated based on Equation (5) listed above. By using the lifetime versus temperature calibration curve as shown in FIG. 3, the simultaneous temperature fields can be constructed. FIG. 7b shows the derived simultaneous temperature field from the phosphorescence image pair shown in FIGS. 5a and 5b.

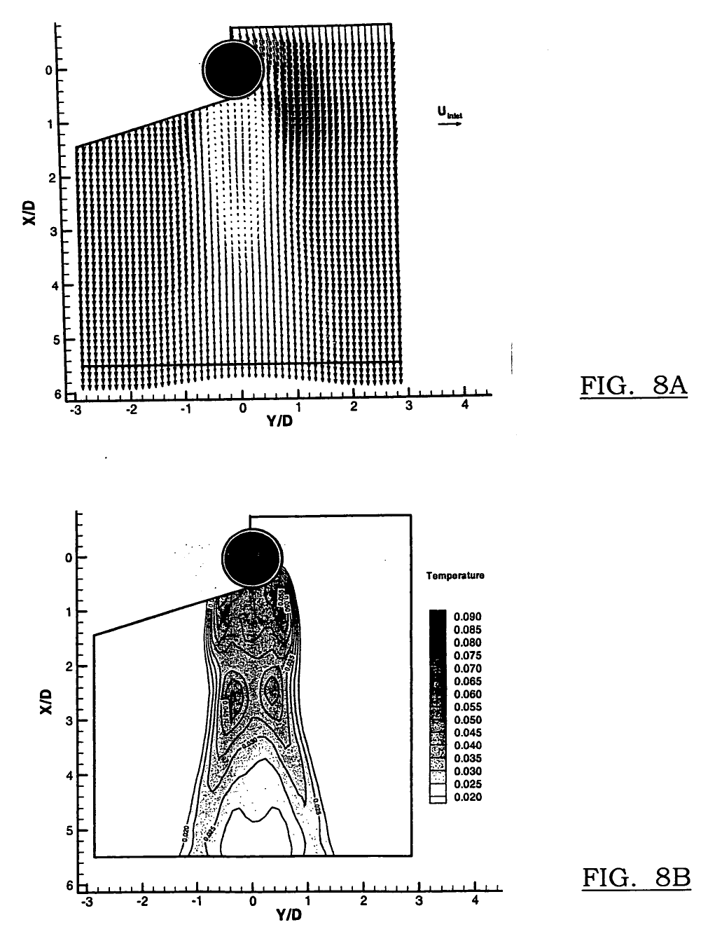

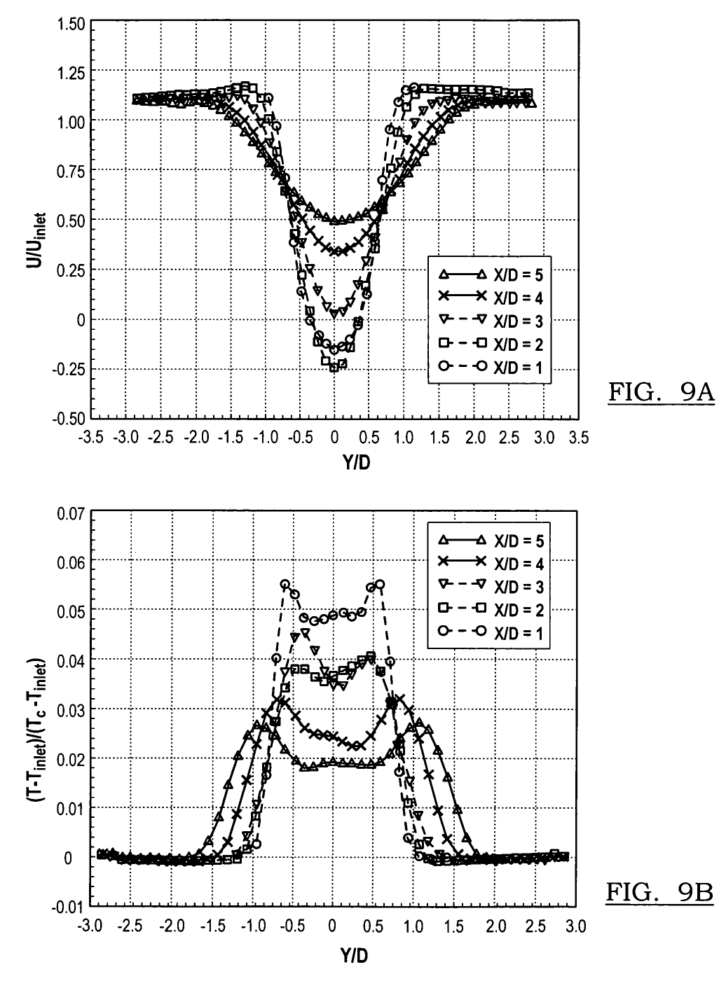

Based on the time sequence of the instantaneous MTV&T measurement results, the mean velocity and mean temperature distributions, temperature and velocity fluctuations as well as the correlation terms between temperature and velocity fluctuations in the measurement regions can be calculated. For example, based on 350 instantaneous MTV&T measurement results like those shown in FIGS. 7a and 7b, the mean velocity and temperature fields in the wake region of a heated cylinder are calculated (see FIGS. 8a and 8b). Sample quantitative transverse profiles of the mean axial velocity and mean temperature at five downtream locations X/D=1, 2, 3, 4 and 5 are given in FIGS. 9a and 9b.

Since the velocity and temperature fields were measured simultaneously by using the MTV&T technique, the correlation between the velocity and temperature can be calculated from the simultaneous measurement results. FIG. 9b shows an example of the distribution of the mean turbulent heat flux (\overline{uⱼ′T′}) in wake of a heated cylinder based on simultaneous velocity and temperature fields as those shown in FIG. 7. The mean turbulent heat flux vector distribution indicates how the heat fluxes were propagated in the wake region of the heated cylinder.

To determine the temperature and velocity within a working fluid, molecular tracers are selected and premixed within the working fluid. A calibration is conducted to quantify the relationship between the photoluminescence intensity decay rate (i.e. lifetime) of the molecular tracers as a function of the temperature change of the working fluids. The photoluminescence molecular tracers can be “tagged” in regions of interest using a collimated or coherent light source. Images of the “tagged” molecules are obtained using cameras. A processor derives the flow velocity vectors from captured images through an image processing procedure. Next, simultaneous fluid temperature distributions are calculated using the calibration profile of photoluminescence intensity decay rate (lifetime) versus fluid temperature is calculated.

The description of the invention is merely exemplary in nature and, thus, variations that do not depart from the gist of the invention are intended to be within the scope of the invention. For example, it is envisioned the apparatus can use a plurality of images viewing the fluid or gas sample to gain 3-dimensional velocity and temperature information. Such variations are not to be regarded as a departure from the spirit and scope of the invention.

What is claimed is:

1. An apparatus for determining the velocity and temperature of a fluid containing a photoluminescent material at a location comprising:
a first beam of light configured to illuminate the location at a time T₀ to energize the photoluminescent material;
an image recorder configured to record the location and intensity of illumination of the photoluminescent material at a time T₁ and to record the location and intensity of the photoluminescent material at a time T₂; and
a control configured to calculate the velocity of the photoluminescent material based on the change of location of the photoluminescent material and to calculate the temperature of the photoluminescent material based on the change of intensity the photoluminescent material between times T₁ and T₂.

2. The apparatus according to claim 1 wherein the photoluminescent material is a supramolecule which is dissolvable within the fluid.

3. The apparatus according to claim 2 wherein the photoluminescent material is 1-BrNp.Gβ-CD.ROH.

4. The apparatus according to claim 1 wherein the controller calculates the phosphorescence lifetime of the photoluminescent material.

5. The apparatus according to claim 4 wherein the apparatus calculates the temperature of the photoluminescent material as a function of the phosphorescence lifetime.

6. The apparatus according to claim 1 wherein the photoluminescent material has a first emission intensity I₁ at T₁ and a second emission intensity I₂ at T₂ and wherein the imager is capable of measuring the second emission intensity at T₂.

7. The apparatus according to claim 6 wherein T₂ minus T₁ is of sufficient duration to allow the image recorder to detect the movement of the photoluminescent material from a position P₁ to a position P₂.

8. The apparatus according to claim 1 further comprising a second beam of collimated light configured to intersect the first beam of light at the location.

9. The apparatus according to claim 1 wherein the imager is a gated intensified CCD camera.

10. The apparatus according to claim 1 further comprising a laser configured to form the first beam light.

11. The apparatus according to claim 8 comprising:
a first mask configured to split the first beam into a first plurality of generally parallel beams of light; and
a second mask configured to split a second beam into a second plurality of generally parallel beams, wherein the first plurality of generally parallel beams intersect the second plurality of generally parallel beams to form an array of beam intersection points that energize an array of illuminated photoluminescent material.

12. The apparatus according to claim 11 wherein the first image recorder is configured to measure a first intensity and a first location for each point of the array of energized photoluminescent material and a second intensity and location for each point of the array of energized photoluminescent material.

13. An apparatus for determining the velocity and temperature of a fluid containing a photoluminescent material at a location comprising:
a first and second beams of coherent light configured to energize the photoluminescent material; and
a first slit array configured to split the first coherent beam into a first set of plurality of generally parallel coherent beams of light and a second slit array configured to split the second coherent beam to a second set of plurality of parallel beams, said first and second sets of parallel beams intersecting to form an array of beam intersection points configured to energize an array of illuminated photoluminescent material at a time T₁;
an image recorder configured to record the location and intensity of illumination of the array of photoluminescent material at a time T₂ and to record the location and intensity of the illuminated photoluminescent material at a time T₃; and a controller configured to calculate the velocity of the array of energized photoluminescent material based on the change of location of the photoluminescent material and to calculate the temperature of the photoluminescent material based on the change of emission intensity of the photoluminescent material between time T₂ and T₃.

14. The apparatus according to claim 13 wherein the photoluminescent material comprises a supramolecule which is dissolvable within the fluid.

15. The apparatus according to claim 13 wherein the photoluminescent material comprises 1-BrNp.Gβ-CD.ROH.

16. The apparatus according to claim 13 wherein the controller calculates a phosphorescence lifetime of the photoluminescent material.

17. The apparatus according to claim 16 wherein the apparatus calculates the temperature of the photoluminescent material as a function of the phosphorescence lifetime.

18. The apparatus according to claim 13 wherein the array of photoluminescent material has a first emission intensity I₁ at T₁ and a second emission intensity I₂ at T₂ and wherein the imager is capable of measuring the emission intensity at T₂.

19. The apparatus according to claim 18 wherein T₂ minus T₁ is of sufficient duration to allow the image recorder to detect the movement of the photoluminescent material from a position P₁ to a position P₂.

20. The apparatus according to claim 16 comprising a controller configured to calculate the temperature of the liquid at least one point using the change of emission intensity.

21. The apparatus according to claim 14 wherein the imager is a pair of CCD cameras.

22. The apparatus according to claim 13 further comprising a laser, configured to produce the first beam of coherent light.

23. The apparatus according to claim 1 wherein the first image recorder is configured to measure a first intensity and location for each point of the array of photoluminescent material and a second image recorder is configured to measure a second intensity and location for each point of the array of the photoluminescent material from a first direction.

24. The apparatus according to claim 23 further comprising a second image recorder configured to measure the first intensity and location for each point of the array of photoluminescent material and the second intensity and location for each point of the array of the photoluminescent material from a second direction.
